(19) United States
(12) Patent Application Publication
(10) Pub. No.: US 2003/0002541 A1
(43) Pub. Date: Jan. 2, 2003

(54) Mid-connect architecture with point-to-point connections for high speed data transfer

(76) Inventors: Michael L. Fowler, Saco, ME (US); Oscar W. Freitas, Cape Elizabeth, ME (US); John F. Whalen JR., Windham, ME (US)

Correspondence Address: Skjerven Morrill MacPherson LLP, 28th Floor, Three Embarcadero Ctr., San Francisco, CA, 94111, US

(21) Appl. No.: 10/165,747

(22) Filed: Jun. 7, 2002

Related U.S. Application Data
(60) Provisional application No. 60/296,624, filed on Jun. 7, 2001.

(51) Int. Cl. H04J 3/04

(52) U.S. Cl. 370/535; 370/537

(57) ABSTRACT

A mid-connect structure having on one side a first set of function cards in parallel with one another and having a plurality of mid-connect elements applied thereto, and having on the other side a second set of function cards in parallel with one another and having a plurality of mid-connect elements applied thereto. The first set of function cards are electrically coupled to the second set of function cards by connecting the mid-connect elements of the first set to corresponding mid-connect elements of the second set. The first set of function cards are oriented at an angle other than parallel relative to the second set of function cards, thereby allowing one or more function cards on one side to be electrically coupled to one or more function cards on the other side. Typically, this would be a perpendicular arrangement of the first set relative to the second set.

### CROSS-REFERENCE TO RELATED APPLICATION

This application claims priority to U.S. Provisional Application No. 60/296,624, filed on Jun. 7, 2001, entitled “Mid-Connect Architecture”, which is incorporated by reference herein.

### BACKGROUND

1. Field of the Invention

The present invention relates to the physical layout of the communication interface architecture for an interconnect system, and more particularly, to a mid-connect architecture with point-to-point connections for high speed data transfer.

2. Background Information

Standards have been established for the architecture of the hardware employed to enable the exchange of electrical signals among processing devices. The processing devices include integrated circuit systems built on and using printed circuit boards by an increasingly wide array of suppliers. The architecture standards ensure that the various devices will, in fact, be able to communicate with one another as well as with central processing units that control the operation of such peripheral devices. These peripherals include, but are not limited to, printer interfaces, video, audio, and graphics interfaces, memory, external communications interfaces, or any other sort of discrete device performing particular computer-related functions.

The circuit boards associated with the peripherals may be activated upon connection with a primary printed circuit board, such as a motherboard, that establishes the physical interconnection of the central processing unit, power, memory structures, and the peripherals through an interconnection structure. The interconnection structure is a primary communication interface coupling device having connections to one or more slots or sockets in parallel into which circuit boards may be inserted. The slots include physical connectors and input/output interfaces to establish reception and transmission of signals among all devices coupled to the motherboard. It is the architecture of the interconnection structure that establishes the interface architectures required for the peripheral boards so that communication can occur between all peripherals and the central processing unit in an organized manner.

The interconnection structure is a printed circuit board or card used to enable the exchange of data (in the form of electrical signals) among other boards or cards connected to it. The structure is typically identified as a backplane having the interconnection slots on one side thereof. The backplane establishes the physical signal exchange interconnection among connected cards. The interconnections are ordinarily established by way of metal wires known as traces. The traces are the physical connections over which electrical signals pass among the various cards associated with the data transmission system. The particular signaling technology running through the traces influences the rate of signal exchange and the number of traces interconnecting individual cards influences signal exchange bandwidth.

Simply stated, the circuit boards or cards that are connected to the interconnection structure either transmit signals or receive signals. A card that is in a transmitting mode is described as a source card while one that is in receiving mode is described as a sink card or destination card. Apart from that most common set of attributes of a card that performs functions involving interaction with other cards, including a central processing unit, there are cards that operate solely to enable signal exchange. They are referred to as intermediate or switch cards in that they only relay signals between source and sink or destination cards. On the other hand, a function card is designed to carry out specified applications. Finally, a line card is a function card that provides for signal exchange with the external world.

As might be expected, the backplanes of interconnection structures take on various forms to provide the particular functionality required. For example, an active backplane includes one or more active elements that provide some logic functionality. That is, they provide some filtering and routing of signals. A passive backplane, on the other hand, provides no such functionality but instead simply provides a physical medium through which signals are routed to and from all connected cards. While it provides no such filtering or routing capability, a passive backplane is important for system reliability in that all signals are permitted to pass through to each connected card, absent some sort of physical problem with a trace or traces.

As is well known in the art, a channel is a physical or optical pathway between the transmitters/receivers of individual cards and/or the central processor, memory, etc., of a data transmission system as well as external interfaces. Each channel is independent and can therefore transfer signals concurrently with other channels. In the field of signal exchange among multiple cards, there are key terms related to the data exchange channels. First, a multi-channel structure is one that includes multiple independent channels providing access from one or more cards to one or more cards. A multi-point channel is a single channel shared by a plurality of transmitting cards. A multi-drop channel, on the other hand, is one that is coupled to a single transmitting or source card but multiple receiving or sink or destination cards. A point-to-point channel is one that has two and only two card connections.

The importance of the backplane architecture established by the channel arrangement to the field of signal exchange is evident. In particular, it is noteworthy that different systems have different signal exchange requirements, and those requirements are dependent upon backplane channel layout. For example, in an equal access system, each card must transmit and receive a similar amount of information. Such systems include, but are not limited to, Local Area Network (LAN) switches, Wide Area Network (WAN) switches, and Redundant Array of Independent Disks (RAID). In a centralized access system, a single master card dominates access to the backplane and controls exchanges on the backplane. Such systems include, but are not limited to, personal computers. In a multiple access system, a plurality of cards require varying degrees of access to the backplane for transmission and reception as a function of time or particular application running. Such systems include, but are not limited to servers such as Internet Service Providers (ISPs).

In any of the systems described above, it is an important goal to provide a signal exchange system that enables signal exchange with little or no disruption. Increasingly, an important feature of the backplane is to provide for the transfer of greater quantities of signals (bandwidth) at faster propagation rates (high speed). Unfortunately, physical layout limitations and impedance concerns associated with the physical interconnections and signal drivers of many cards restricts high bandwidth, high speed signal transfer. Multi-channel, point-to-point or signal switch fabric interface (SSFI) backplane architecture has been recognized as a reasonable means to maximize signal bandwidth and propagation rates with high reliability. It is suitable for use in centralized and equal access environments. The SSFI backplane involves point-to-point connections enabling an increase in the number of cards connected to the backplane and greater channel access with a minimum number of backplane connections. However, the focus of high-speed signal change has been on internal switching, including through the use of midplane structures rather than backplane structures. There remains a need to increase the speed of data transmission in communications among external systems.

Therefore, what is needed is an interconnection structure that provides for high bandwidth, high-speed data transfer with little to no impact on signal integrity. Further, what is needed is such an interconnection structure that can be implemented using interface components substantially compatible with new and legacy circuit board interfaces. Yet further, what is needed is a high bandwidth, high speed interconnection structure suitable for deployment in the type of physical space generally available for computing systems. What is also needed is such an interconnection structure that makes efficient use of physical connectors or traces to reduce the impedances associated therewith. An additional need is to increase transmission rates for external signal exchange.

### SUMMARY OF THE INVENTION

The present invention relates to the physical layout of the communication interface architecture for an interconnect system. More particularly, the present invention relates to establishment of the connections among individual circuit boards or cards of a system. The cards may be used for internal signal exchange among boards of the system or for external signal exchange between other systems or system boards such as would be used in a computer or data transmission system, though this invention applies to the actual interconnect within the system. The present invention provides for improved signal exchange at high speed through unique card-interconnect architecture.

The present invention comprises an interconnection structure that provides for high bandwidth, high speed data transfer while minimizing impact on signal integrity. In one embodiment, the present invention can provide an interconnection structure that can be implemented using interface components substantially compatible with new and legacy circuit board interfaces. In this or another embodiment, the invention provides an interconnection structure that does not utilize a printed circuit board, such as a backplane or midplane, to connect the various cards. The invention also provides a high bandwidth, high-speed interconnection structure suitable for deployment in the type of physical space generally available for computing and data transmission systems. Furthermore, the invention provides an interconnection structure that makes efficient use of physical connectors and traces to reduce the impedances associated therewith.

In one embodiment, the invention comprises a mid-connect structure rather than a backplane or midplane structure. More specifically, the invention comprises a mid-connect structure having on one side thereof a first set of function cards in parallel with one another and having a plurality of mid-connect elements applied thereto, and having on the other side thereof a second set of function cards in parallel with one another and having a plurality of mid-connect elements applied thereto. The first set of function cards are electrically coupled to the second set of function cards by connecting the mid-connect elements of the first set to corresponding mid-connect elements of the second set. The first set of function cards are oriented at an angle other than parallel relative to the second set of function cards. This allows one or more of the function cards on one side to attach to one or more of the function cards on the other side. Typically, this would be a perpendicular arrangement of the first set relative to the second set.

In another embodiment of the invention, the first set of function cards can include a first switch card and the second set of function cards can include a second switch card. The switch cards can establish all of the electrical interconnections in this embodiment. The first set of function cards can be electrically interconnected to one another through the second switch card, the second set of function cards can be electrically interconnected to one another through the first switch card, and the first set of function cards can be electrically interconnected to the second set of function cards through a combination of both the first and second switch cards. The switch cards can then provide a point-to-point switch fabric such that each connected function card has an interface to all other function cards through the switch cards.

To enable the high bandwidth, high-speed signal exchange indicated using the mid-connect configuration described, it is preferable to provide as part of the invention suitable signal transfer circuitry. The signal transfer circuitry should provide signal propagation substantially independent of particular signal exchange protocols. Accordingly, in an embodiment, each switch card includes, and each line or function card preferably includes, transceiver drivers suitable for high frequency propagation. These drivers include, for example, Gunning Transceiver Logic Plus (GTLP), Low Voltage Differential Signal (LVDS), and Positive Emitter Coupled Logic (PECL) drivers. The switch drivers enable signal propagation among cards and to upstream interfaces, such as internal circuitry of a data transmission system including the mid-connect or for interfacing to external devices. For the purpose of this disclosure, line and function cards will be referred to as function cards.

The design of the switch cards is important in the scheme of the invention. The switch cards should be configured with the processing logic necessary to ensure proper transfer of signals among the various cards connected in the slots of the mid-connect. In one embodiment, the processing logic is configured to recognize all signal transmission protocols so that cards with differing protocols may interface with one another. Therefore, the mid-connect of the invention can be independent of signal protocols and can be suitable as an exchange for legacy and future card protocols. The switch cards of the invention therefore employ, in an embodiment, SerDes and crosspoint switching configurations of the type well known in the art. Moreover, data packeting and arbitration logic are relatively simple to maximize reliable throughput.

These and other advantages of the invention will become apparent upon review of the following detailed description, the accompanying drawings, and the appended claims.

### BRIEF DESCRIPTION OF THE DRAWINGS

FIG. 1 is a perspective view of the mid-connect layout of the present invention showing an exemplar set of 21 switch cards interconnected to 21 function cards.

FIG. 2A is a detailed perspective view of the connecting of an exemplar switch card to an exemplar function card.

FIG. 2B is a detailed view of a pair of through connectors formed of a female connector and a male connector used to connect an exemplar switch card to an exemplar function card.

FIG. 2C is a detailed perspective view of the connecting of an exemplar switch card to an exemplar function card using an optical connection.

FIG. 2D is a detailed perspective view of the connecting of an exemplar switch card to an exemplar function card using an optical connection, wherein the optical connection comprises both an optical transmitter and an optical receiver that is employed at both the switch card and at the function card.

FIG. 3 is front view of an exemplar switch card coupled to a plurality of function cards.

FIG. 4 is front view of an exemplar function card coupled to a plurality of switch cards in a first switch arrangement.

FIG. 5 is a front view of an exemplar function card coupled to a plurality of switch cards in a demultiplexer connection arrangement.

FIG. 6 is a perspective view of a mid-connect layout of the present invention showing the mid-connect structure as a midplane structure.

FIG. 7 is a perspective view of a mid-connect layout of the present invention showing a multi-plane switching, mid-connect interconnection system.

FIGS. 8A to 8C are top views of different embodiments of the multi-plane switching, mid-connect interconnection system of FIG. 7.

FIG. 9 is a perspective view of a System Area Network in a Box (SANB) constructed using the mid-connect interconnection system of the present invention.

### DETAILED DESCRIPTION

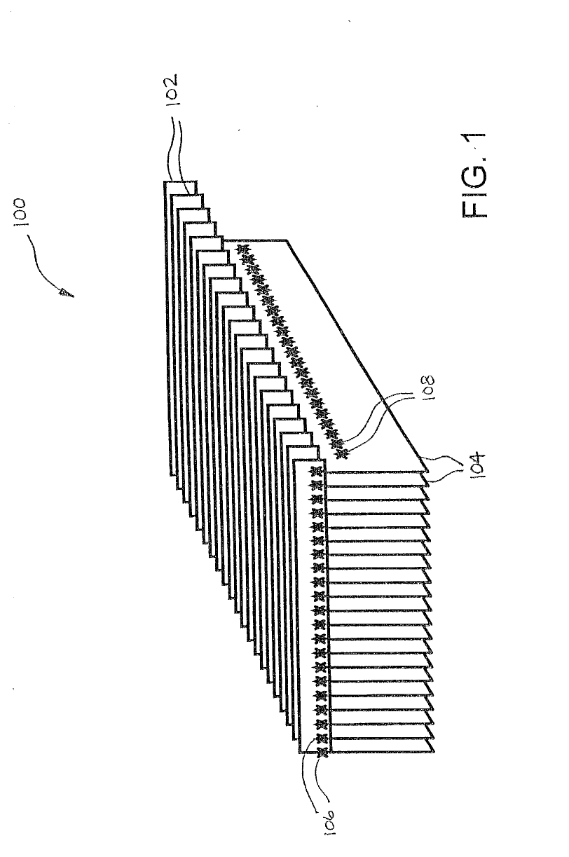

FIG. 1 shows a mid-connect interconnection system 100 according to one embodiment of the invention. This embodiment includes a plurality of switch cards 102 and a plurality of function cards 104 interconnected each directly to the other through a connector arrangement. Mid-connect interconnection system 100 is configured such that switch cards 102 are perpendicularly oriented relative to function cards 104. In such an orientation, each switch card 102 is in electrical contact with every function card 104, and therefore the switching circuitry of each switch card 102 can be directly connected to all of function cards 104. This arrangement effects a direct connection of each function card 104 to all other function cards 104 through switch cards 102. Switch cards 102 can include switch card side interfaces 106 to function cards 104. Likewise, function cards 104 can include function card side interfaces 108 to switch cards 102. Interfaces 106 and 108 can comprise switch devices or drivers/receiver pairs to complete signal propagation among function cards 104.

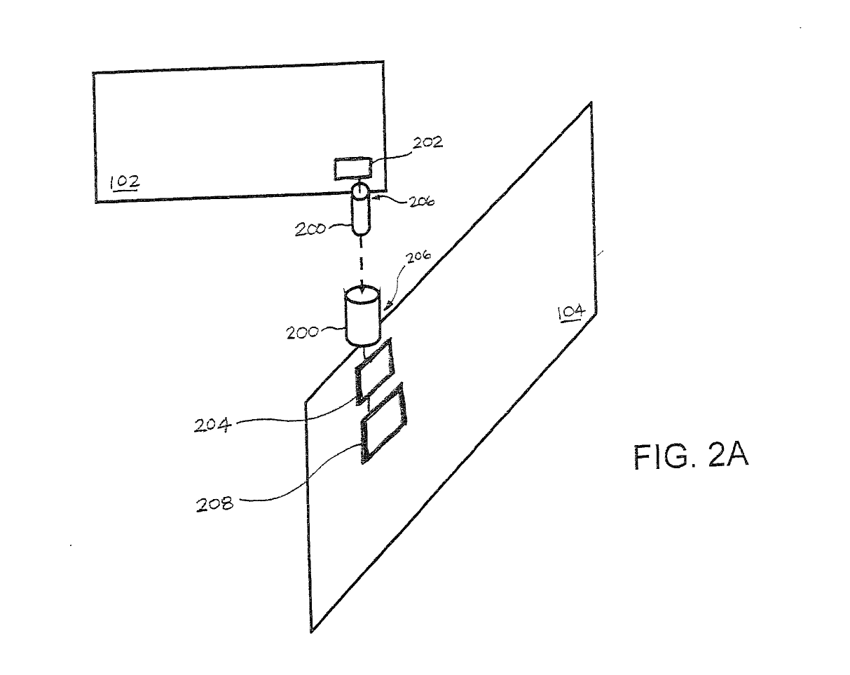

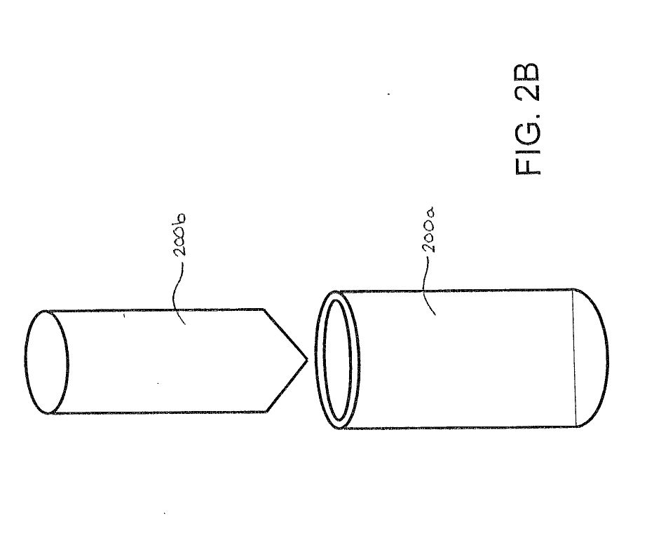

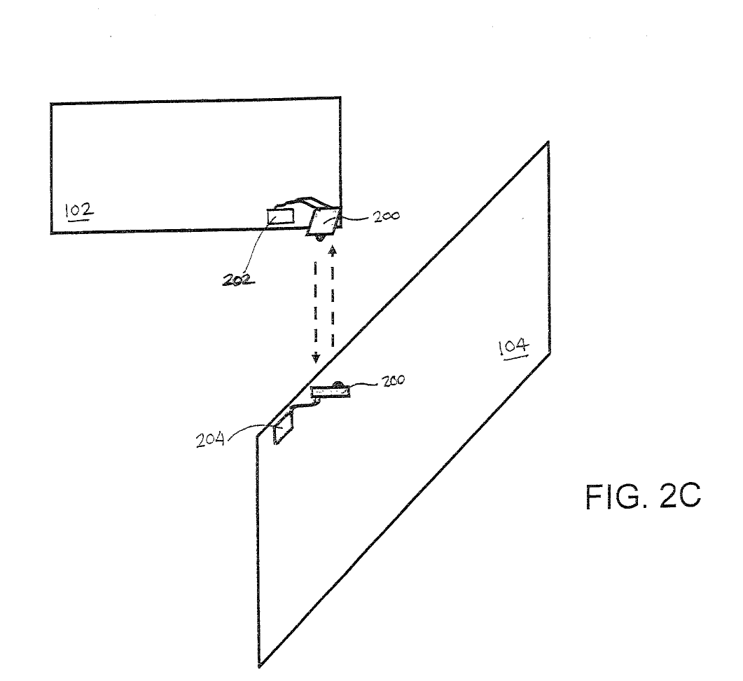

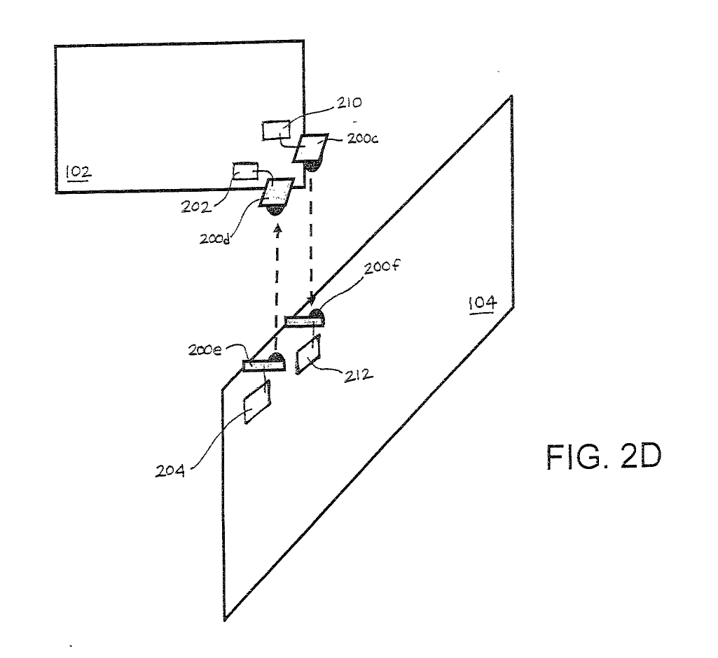

Turning to FIG. 2A, in an embodiment, mid-connect interconnection system 100 includes a plurality of through connectors 200 to establish the interconnection of switch cards 102 to function cards 104. Connector pairs 200 between switch cards 102 and function cards 104 provide for fast signal transmission with minimal reflections and without the need for a backplane or a midplane structure. Interface devices, such as drivers, receivers, or full duplex driver/receiver pairs 202 and 204, can be employed on each of cards 102 and 104 to establish a suitable electrical signal exchange.

Generally, each switch card 102 preferably has a discrete driver/receiver pair 202 for each connector, while each function card 104 includes a similar discrete driver/receiver pair 204. In some embodiments, driver/receiver pairs may be employed solely on switch cards 102 or solely on function cards 104. Driver/receiver pairs 202 and 204 are located proximate to connector 200, thereby minimizing stub length between connector 200 and driver/receiver pairs 202 and 204. This enables a high-speed data transfer between driver/receiver pairs 202 and 204. Further, each function card 104 can also include an on-card driver/receiver pair 208, generally embedded in an Application-Specific Integrated Circuit (ASIC) or Application-Specific Standard Product IC (ASSP) chip. In embodiments where cost is more important than the rate of data transfer, the invention can eliminate the use of driver/receiver pairs 202 and 204 and rely instead on the ASIC or ASSP driver/receiver pair 208.

In an exemplary arrangement having twenty-one switch cards and twenty-one function cards, a 21×21 array of through connectors 200 is required. As shown in FIG. 2A, to provide substantially maximum frequency performance, it is possible in an embodiment of this invention to place drivers/receiver pairs 202 and 204 directly at card edges 206 of connector 200 to minimize stub length on both sides of connector 200. Drivers/receiver pairs 202 and 204 are preferably coupled to each of connectors 200 for optimum frequency transmission. It should be noted that driver/receiver pairs 202 can take the form of a full duplex transceiver as well. Since there is generally only one connector 200 and no traces between driver/receiver pairs 202 and 204, there is a minimal distance for the signal to traverse, thus reducing impedance and variances in impedance in the distance that the signal must travel, and thereby maximizing the frequency performance of the signal. To further enhance the high performance capability on the card, it is possible to either multiplex the signal at driver/receiver pair 202, or demultiplex the signal at driver/receiver 204. It is also possible to produce a maximum frequency signal on the card since this is a point-to-point connection in a well controlled impedance environment of a printed circuit board with no connectors 200 between driver/receiver pair 202 on the card causing unwanted changes in impedance.

As shown in FIG. 2B, in one embodiment connectors 200 may be established as a set of pairs or sets of pairs of through connectors 200 formed of a female connector 200a and a male connector 200b. Female connector 200a includes a socket into which male connector 200b fits. Those skilled in the art will readily recognize that such connectors can be deployed in the cards. Further, those skilled in the art will recognize that alternative means can be employed to establish short-length connections between switch cards 102 and function cards 104. Moreover, the invention can be arranged so that female connectors 200a are established on switch cards 102 and male connectors 200b are established on function cards 104, or vice-versa.

As shown in FIG. 2C, in an alternative embodiment, connectors 200 can be established as an optical connection between switch card 102 and function card 104. As in other embodiments, driver/receiver pairs 202 and 204 can be located proximate to each connector 200 for optimum frequency transmission. When an optical connection is used, a backplane is not required. For multi-point, duplex mode connections, connector 200 will comprise two pairs of optical connectors. As shown in FIG. 2D, an optical transmitter 200c and an optical receiver 200d can be employed at switch card 102, while a corresponding optical transmitter 200e and optical receiver 200f can be employed at function card 104 as well. Driver/receiver pairs 202 and 204, as well as additional driver/receiver pairs 210 and 212, can be located proximate to each connector 200 for optimum frequency transmission.

The arrangement of sets of pairs of through connectors 200 is determined by a user as a function of throughput required, transceiver technology employed, and layout space available. In embodiments of the invention, card cages can be used to hold switch cards 102 and function cards 104 stable, and a support structure can also be deployed between cards. In the arrangement of mid-connect interconnection system 100 shown in FIG. 1, the communication established is multi-channel, point-to-point with full duplex connections. However, in alternative embodiments, any sort of communication form may be employed with system 100 of the invention including, but not limited to, unidirectional and bi-directional communications. Of course, two trace sets of through connectors 200 are generally required for bi-directional communication. Full duplex communication enables sourcing and sinking from or to each function card 104 via switch cards 102, and it doubles the performance parameters compared to unidirectional transmission. Alternatively, unidirectional operation halves the number of required trace sets as that of the bi-directional embodiment.

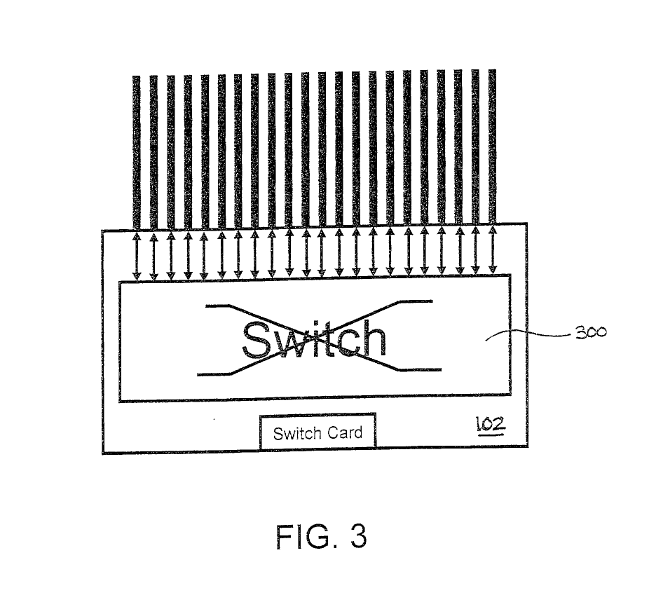

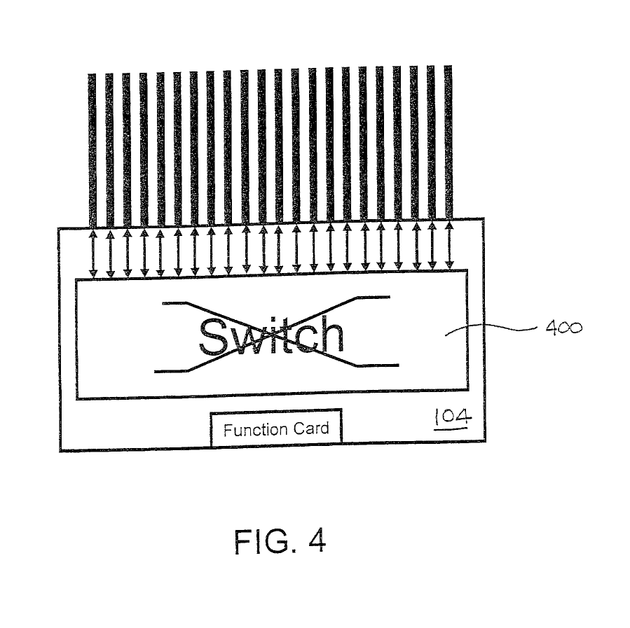

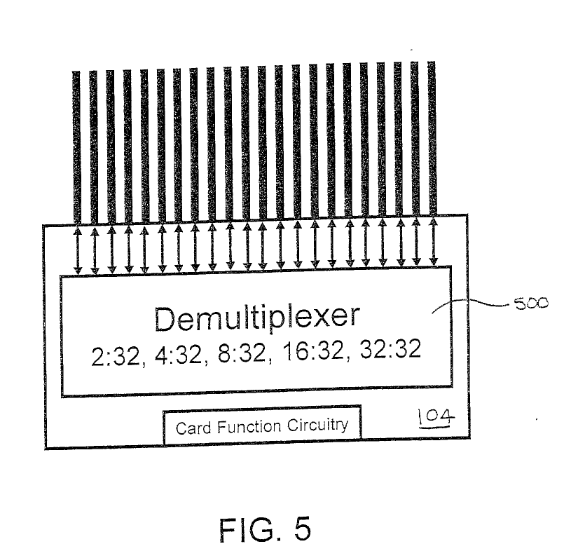

As illustrated in the embodiments of FIGS. 3 and 4, each switch card 102 can include a switch device 300, and each function card 104 can include a switch device 400. In another embodiment, as shown in FIG. 5, a demultiplexer 500 can be employed on one or more of function cards 104 to reduce the number of direct connections associated with switch cards 102. Each of the respective switch devices 300 and 400 may be selected by the user, but switch devices that are particularly well suited for use in the invention include, for example, the LVDS family of switches offered by Fairchild Semiconductor Corporation of South Portland, Me. Alternatively, a Positive Emitter Coupled Logic (PECL) switch may be employed, particularly to maximize throughput. In the arrangement shown in FIG. 4, each function card 104 has the full bandwidth of X Gbps by Y switch connections available. In other embodiments, resources can be located on switch cards 102, if desired. Moreover, effective redundancy can be accomplished by deselecting a switch card 102 upon the failure of that single switch card 102. For the arrangement shown in FIG. 5, each function card 104 has the full bandwidth of X Gbps by Y switch connections available, while the demultiplexer allows for a lesser number of switch cards 102 to be connected, thus improving scaling performance.

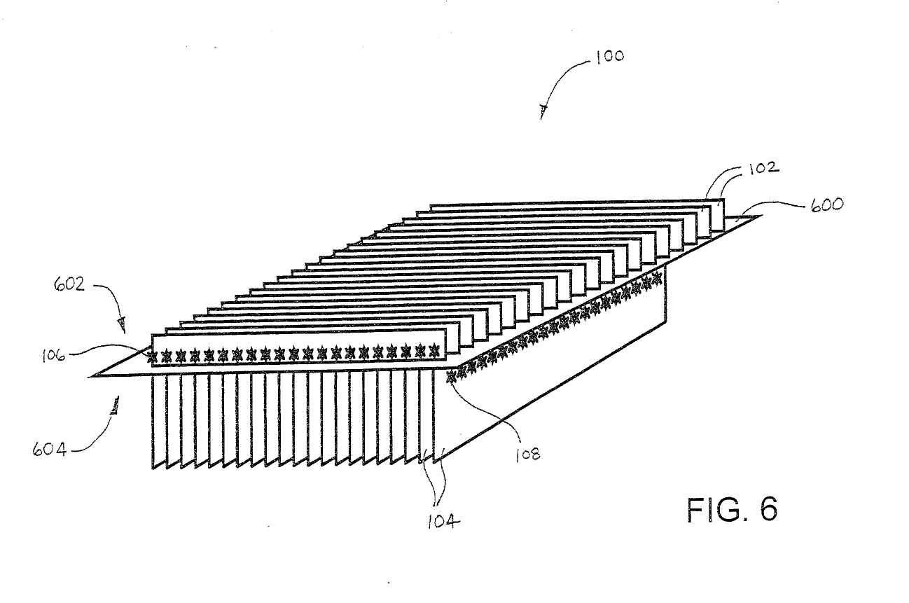

In an alternative embodiment of the invention shown in FIG. 6, mid-connect interconnection system 100 of the invention comprises a printed circuit board such as a midplane structure 600 that functions as a card cage to support and align switch cards 102 on a first mid-connect side 602, and to support and align function cards 104 on a second mid-connect side 604, in a connection manner well known to those skilled in the art. Connectors 200, with accurate alignment provided by midplane structure 600 as they are attached to switch cards 102 and function cards 104, may each be unitary and pass completely through the body of the structure 600, or they may be discrete elements on each of sides 602 and 604 but electrically coupled together.

With continuing reference to FIG. 6, midplane structure 600 is configured with a plurality of slots on each of sides 602 and 604 for receiving therein a selectable, number of switch cards 102 and a selectable number of function cards 104, respectively. The slots of structure 600 are arranged so that switch cards 102 are perpendicularly oriented relative to function cards 104. As explained above, in such an orientation, the switching circuitry of respective switch cards 102 can be directly connected to all of function cards 104 to effect a direct connection of each function card 104 to all other function cards 104 through switch cards 102. Switch cards 102 can include switch devices 300 and function cards 104 can include switch devices 400 to complete signal propagation interfaces among function cards 104. Alternatively, switch cards 102 and function cards 104 can include drivers/receiver pairs 202 and 204 (as shown in FIG. 2) for signal propagation.

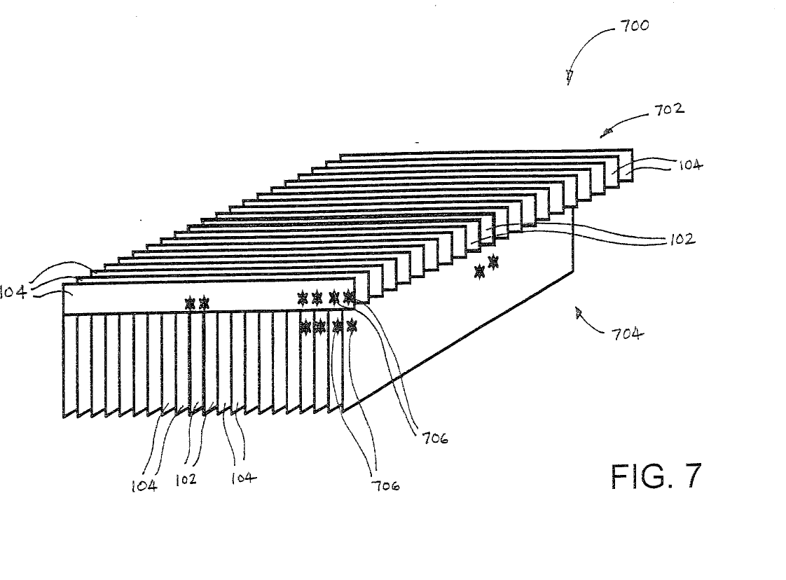

In another embodiment of the invention, it may be desirable to provide direct connections between two function cards 104 or sets of function cards 104, rather than providing point-to-point connections through switch cards 102. Accordingly, FIG. 7 shows an embodiment of the invention that comprises a multi-plane switching, mid-connect interconnection system 700, which includes switch cards 102 and function cards 104 in both a first plane 702 and a second plane 704 of the invention. In the embodiment of FIG. 7, there are two switch cards 102 in each plane 702 and 704 of mid-connect interconnection system 700. The remaining cards are function cards 104. It should be noted that the number of switch cards 102 is not restricted to any particular number, and each plane can have anywhere from 0% to 100% of its slots filled with switch cards 102. The remaining slots are accordingly filled with function cards 104. In FIG. 7, two switch cards 102 are provided in each plane 702 and 704 for purposes of redundancy.

Having function cards 104 in both planes 702 and 704 of mid-connect interconnection system 700 allows all of function cards 104 in plane 702 to be directly coupled to all of function cards 104 in plane 704. The direct connections can be through switches or multiplexer/demultiplexer pairs located on function cards 104 themselves, or through direct point-to-point connections to and from a function or resource block on two or more cards. The connections can also be between multiple functions on a single card or multiple channels to an individual function. In the embodiment of FIG. 7, there can be an electrical connection between function cards 104 at every intersection of function cards 104, or there can be connections only between select function cards 104, dependent upon where connections between function cards 104 are required.

In the embodiment of FIG. 7, system sections can be partially isolated from one another within a card cage. This can be beneficial in optimizing performance of the system when there are multiple, independent functional blocks in the system. One example of such a system with multiple functional blocks is a single overall system providing all of the functionality required for an Infiniband Subnet, or an Internet or Application Service Provider physical site comprised of routers, switches, storage, and servers. All of these functions can fit well into mid-connect interconnection system 700 using the direct connections between function cards 104. Isolation of functional blocks within a system can also prove useful for security purposes.

As with previous embodiments, interfaces 706 can be provided on function cards 104 to complete signal propagation among function cards 104. Interfaces 706 can comprise switch devices or drivers/receiver pairs, and can directly couple function cards 104 in plane 702 to function cards 104 in plane 704.

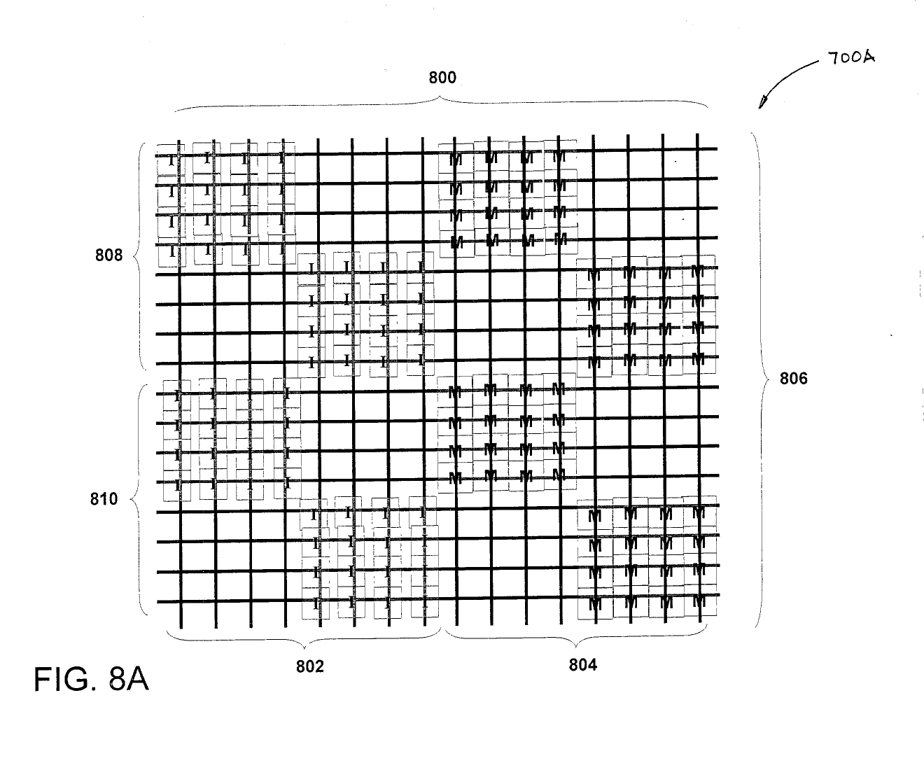

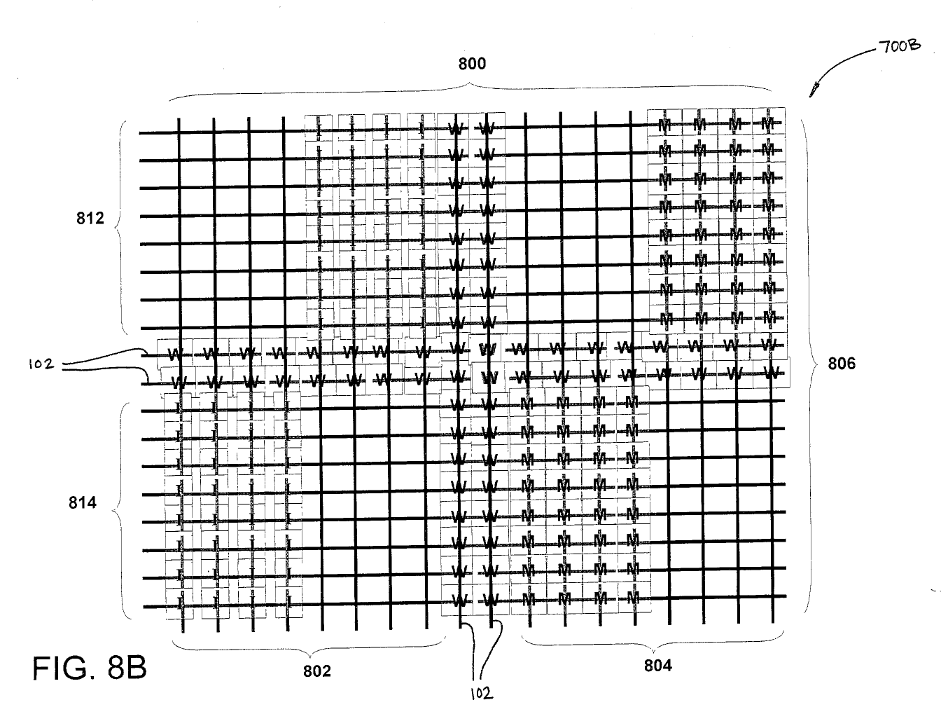

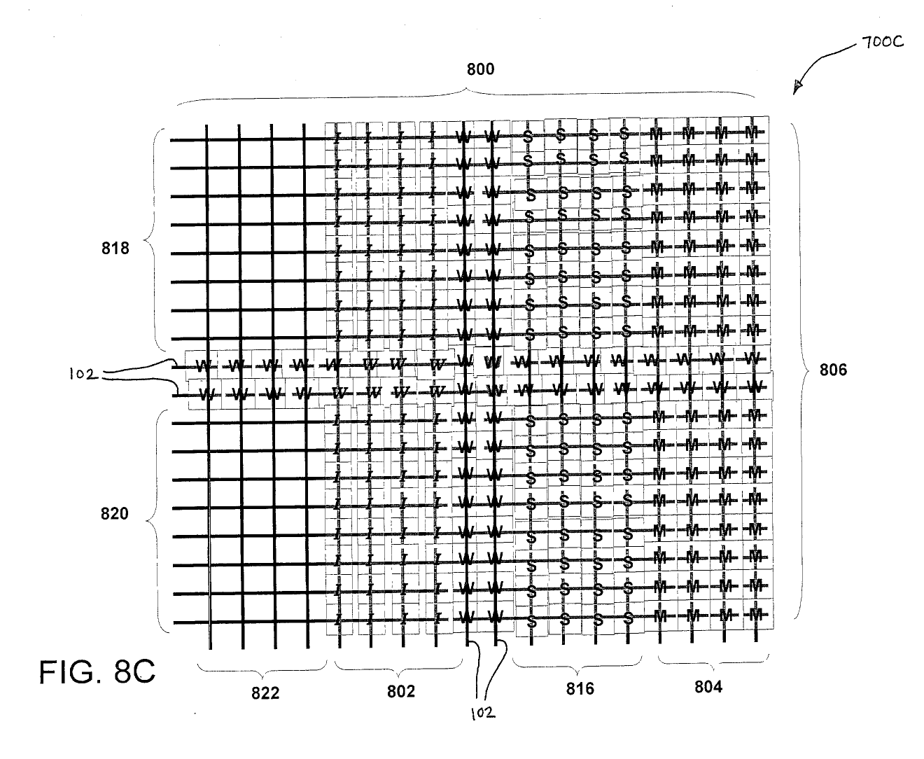

FIGS. 8A to 8C are top-views of different embodiments of mid-connect interconnection system 700. Each line in FIGS. 8A to 8C represents a function card 104. FIG. 8A illustrates an embodiment of mid-connect system 700, herein labeled 700A, with primary storage and processing function cards 104 using only direct, card-to-card connections, and no switch cards 104. In this embodiment, function cards 104 in a first plane 800 comprise input/output cards 802 and memory cards 804. Memory cards 804 generally contain memory commonly found in computer systems, including but not limited to DRAM memory. In a second plane 806 of system 700A, function cards 104 comprise two sets of cards 808 and 810 that can perform different tasks. In FIG. 8A, system 700A comprises a 16×16 array of function cards 104, although in alternate embodiments any number of function cards 104 can make up the array. In FIG. 8A, the label “I” on the connections between input/output cards 802 and cards 808 and 810 indicates a connection where input/output data is passed. And the label “M” between memory cards 804 and cards 808 and 810 indicates a connection where memory data is passed.

FIG. 8B illustrates an embodiment of system 700, herein labeled 700B, with primary storage and processing function cards 104 with independent support cards (input/output and memory) for each. As in FIG. 8A, first plane 800 comprises input/output cards 802 and memory cards 804. Second plane 806 comprises a set of storage cards 812 and a set of processor cards 814. Half of input/output cards 802 are used by storage cards 812, and half are used by processor cards 814. Likewise, half of memory cards 804 are used by storage cards 812, and half are used by processor cards 814. Furthermore, system 700B includes two pairs of switch cards 102, one pair disposed in plane 800, and the second pair disposed in plane 806. As before, the label “I” indicates a connection where input/output data is passed, and the label “M” indicates a connection where memory data is passed. In addition to there, in FIG. 8B the label “W” indicates a switch connection.

In FIG. 8C, an embodiment of system 700, labeled system 700C, is shown containing function cards 104 comprising primary processing cards with common support cards and storage cards. Function cards 104 of plane 800 include input/output cards 802, memory cards 104, a pair of switch cards 102, and storage cards 816. Memory cards 104 generally contain volatile memory, such as DRAM, while storage cards 816 generally contain non-volatile memory, such as a hard disk drive. Function cards 104 of plane 806 include two sets of processor cards 818 and 820. Furthermore, plane 800 can include wild cards 822 that can be used for any desired functionality. In FIG. 8C, in addition to the previously mentioned labels, the label “S” indicates a connection over which storage data is passed.

It should be noted that the embodiments shown in FIGS. 8A to 8C are merely three examples of the limitless number of embodiments possible for mid-connect interconnection system 700. All types of function cards 104 that are available can be used in this invention, and in any number. Likewise, more or less than two switch cards 102 can be used in any embodiment as well.

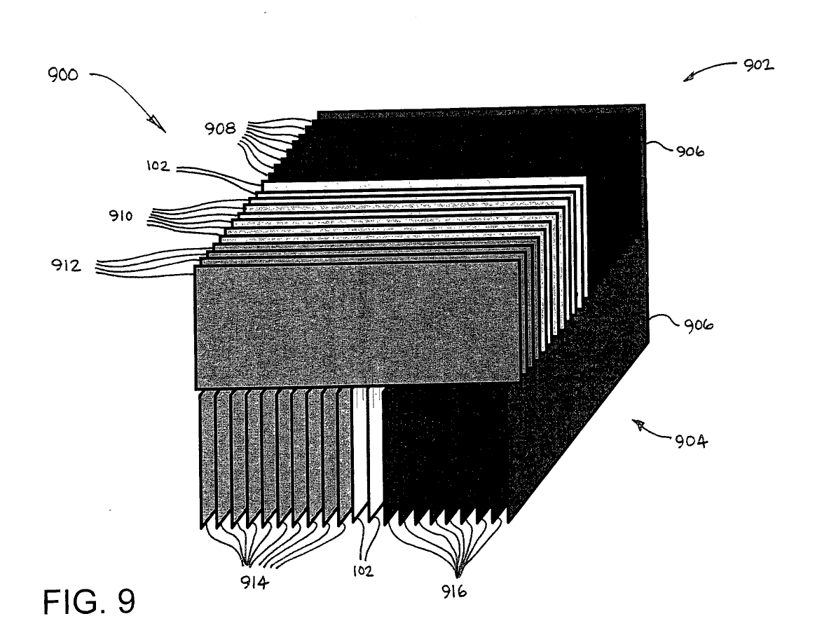

Turning to FIG. 9, another embodiment of the invention is shown that comprises a System Area Network in a box (SANB) 900. In SANB 900, it is possible to put all of the components from a System Area Network into a single structure while allowing for modular scalability of any component as required by the system expansion needs. In one embodiment of SANB 900, the preferred method can be to use switch connections only, though direct connections can be used for higher performance on specific connections between specific function cards 104. As many connections are possible at the intersection of function cards 104 from the two planes of SANB 900 as can be fit into the spacing between these function cards 104. At the intersection of switch cards 102, the invention can provide many connections to adequately address the bandwidth needs caused by many function cards 104 attempting to access through switch cards 102 in both planes.

All of the conventional components of a System Area Network, such as routers, switches, servers, storage, RAIDs, I/O, and memory, can be placed into the architecture of SANB 900 as card components. If SANB 900 is a switch-connect system only, then any of the card components can be placed at any card location except slots that are dedicated to switch cards 102, since the switch component connector configuration is different. If all intersections between function cards 104 have connectors, then any function card 104 can be placed in any slot of SANB 900.

In FIG. 9, SANB 900 comprises two planes 902 and 904. In plane 902, SANB 900 includes function cards 104 consisting of at least one router card 906, memory cards 908, storage cards 910, and input/output cards 912. There are also two switch cards 102 in plane 902. In plane 904, function cards 104 include director cards 914, and server cards 916. Plane 904 also includes a pair of switch cards 102, and at least one router card 906.

The mid-connect interconnection system of the present invention allows for easy upgrading to the next level of performance, since there is no fixed backplane or midplane between function cards 104. In the case of multi-plane switching, all that is required is that switch cards 102 be changed with backward compatible upgraded switch cards 102. Then all other cards, namely function cards 104, can be upgraded as well.

This ability to upgrade the card interconnections is due to the fact that there is no printed circuit card to limit the connections. Every connector and card is an isolated, replaceable piece of the system. When configured correctly, the ability to add connections, provide higher speed connections, or change transmission media (i.e. electrical to optical) is possible. It is preferred to leave the original connector as part of the new connection scheme to allow for backward compatibility to the original components of the system. It is also preferred to leave expansion room available between connectors to be able to widen the connector with more connections.

The distribution of power within mid-connect interconnection systems 100 and 700, or within SANB 900, presents a unique challenge to the virtual backplane architecture of the invention. In the absence of an actual printed circuit board for card interconnect, a new way to distribute power between cards is required. In the case of a multi-plane switching system, with dedicated switch cards 102 in each plane of the system, the task can be relatively straightforward. In one embodiment, power distribution can reside on switch cards 102 with power connections provided for each of function cards 104 in the opposing plane. Since switch cards 102 are generally present in a switch based system, power would always be present. In the embodiment used for redundancy, which requires at least two switch cards in each plane, power redundancy would also be provided.

Another approach if switch card 102 cannot be used to supply power, or in the instance of a non-switch card based system, would be to dedicate slots to the power distribution task. Again, two power distribution slots or cards in each plane with connections from each power card to each function card 104 in the opposing plane would allow for redundancy.

Mid-connect systems 100 and 700, as well as SANB 900, of the present invention establish a signal switching fabric interface that enables high bandwidth, high-speed throughput. Use of the present invention eliminates the need for a backplane or midplane card, thereby allowing any failures to be single point failures, and providing for limitless upgradeability. The invention creates a very dense system structure, approaches subnet level complexity, maximizes link speeds, and provides for simple optical connections, The invention also provides multi-stage connects, including direct card-to-card interconnects, multiplexed connects, single-stage switching, and multi-stage switching.

The invention has a wide array of applications including, but not limited to, multi-processor servers, LAN and WAN routers and switches, and RAIDs. Further, the switch cards can be configured to manage any sort of signal propagation protocol including, but not limited to, Ethernet, Fibrechannel, Infiniband, and RapidIO, for example, each having its particular switch architecture. The point-to-point arrangement described permits the simplest form of data transmission to fit into the space available, especially if high-speed transceivers are employed such as is available through GTLP, LVDS, and PECL. This enables a system providing minimum distance between connections for a virtually unlimited number of switch cards 102 and function cards 104, with a virtually unlimited number of channels.

It is contemplated that the present invention provides a convenient layout capable of handling channel speeds of the type associated with Ethernet, Infiniband, and Synchronous Optical Network (SONET/SDH), for example, and with substantially more cards than has heretofore been possible. In particular, 2.5 Gigabits per second (Gbps) transmission may be generated using the transceiver drivers identified. In the exemplar mid-connect arrangement shown in a full duplex mode, with 21 switch cards and 21 line cards, it is possible to provide a bandwidth on the order of 21×21×2×2.5 Gbps=2.205 Terabits per second. That sort of bandwidth is enabled in the invention using an efficient connection layout in a board space of the type currently available and with transceiver drivers currently available.

Similar performance can be shown for a computer system, rather than a data transmission system, without the need for the switches on the function cards. In this case, to provide scalable performance, a variable number of input deserializers would be required on the function cards. In this way, the number of switches could be adjusted to the scaled performance requirements.

While the invention has been described with reference to particular example embodiments, it is intended to cover all modifications and equivalents within the scope of the following claims.

What is claimed is:

1. An interconnection system for electrically coupling together a plurality of function cards, the interconnection system comprising:
a first set of function cards in parallel with one another and having a plurality of mid-connect elements applied thereto; and
a second set of function cards in parallel with one another and having a plurality of mid-connect elements applied thereto, wherein the first set of function cards are electrically coupled to the second set of function cards by connecting the mid-connect elements of the first set to corresponding mid-connect elements of the second set,
wherein the mid-connect elements are arranged such that when the first set of function cards are connected to the second set of function cards, each function card of the first set can be electrically coupled to more than one function card of the second set.

2. The interconnection system of claim 1, wherein the first set of function cards is oriented substantially perpendicular to the second set of function cards.

3. The interconnection system of claim 1, wherein the number of function cards in the first set of function cards is equal to the number of function cards in the second set of function cards.

4. The interconnection system of claim 1, wherein the mid-connect elements of the first set comprise male stub connectors and the mid-connect elements of the second set comprise female stub connectors.

5. The interconnection system of claim 1, wherein the mid-connect elements of the first set and of the second set comprise optical transmitters and receivers.

6. The interconnection system of claim 1, wherein one or more function cards of the first set include a switch device to facilitate signal routing.

7. The interconnection system of claim 1, wherein one or more function cards of the second set include a switch device to facilitate signal routing.

8. The interconnection system of claim 1, wherein one or more function cards of the first set include a discrete driver/receiver pair proximate to the mid-connect element to enable high-speed data transfer.

9. The interconnection system of claim 1, wherein one or more function cards of the second set include a discrete driver/receiver pair proximate to the midconnect element to enable high-speed data transfer.

10. The interconnection system of claim 1, wherein one or more function cards of the first set include an ASIC or ASSP chip to enable the driving and receiving of electrical signals.

11. The interconnection system of claim 1, wherein one or more function cards of the second set include an ASIC or ASSP chip to enable the driving and receiving of electrical signals.

12. The interconnection system of claim 1, wherein the first set of function cards and the second set of function cards comprise:
at least one router card;
at least one memory card;
at least one storage card;
at least one switch card;
at least one input/output card; and
at least one server card.

13. The interconnection system of claim 6, wherein the switch device comprises a multiplexer/demultiplexer.

14. The interconnection system of claim 7, wherein the switch device comprises a multiplexer/demultiplexer.

15. An interconnection system for electrically coupling together a plurality of function cards, the interconnection system comprising:
a first set of function cards in parallel with one another and having a plurality of mid-connect elements applied thereto;
a second set of function cards in parallel with one another and having a plurality of mid-connect elements applied thereto, the second set of function cards being oriented substantially perpendicular to the first set of function cards;
a first switch card in parallel with the first set of function cards and having a plurality of mid-connect elements applied thereto; and
a second switch card in parallel with the second set of function cards and having a plurality of mid-connect elements applied thereto,
wherein by connecting the mid-connect elements of the first set of function cards to corresponding mid-connect elements of the second switch card, the first set of function cards are electrically interconnected to one another through a first switch device located on the second switch card,
wherein by connecting the mid-connect elements of the second set of function cards to corresponding mid-connect elements of the first switch card, the second set of function cards are electrically interconnected to one another through a second switch device located on the first switch card, and
wherein by electrically coupling the first switch card to the second switch card, each function card of the first set is electrically interconnected to each function card of the second set through a combination of the switch devices of the first and second switch cards.

16. The interconnection system of claim 15, wherein two or more switch cards are used in parallel with the first set of function cards, and two or more switch cards are used in parallel with the second set of function cards.

17. The interconnection system of claim 15, wherein one or more function cards of the first set are directly coupled to one or more function cards of the second set, thereby establishing an electrical connection that is independent from the switch cards.

18. An interconnection system for electrically coupling together a plurality of function cards comprising:
at least one function card mid-connect element applied to each of the function cards; and
at least one switch card having a plurality of switch card mid-connect elements applied thereto, wherein the switch card includes a switch device for interconnecting each of the function cards to one another by connecting the function card mid-connect elements to corresponding switch card mid-connect elements,
wherein the mid-connect elements are arranged such that when the function cards are connected to the switch card, each function card is connected to at least one other function card.

19. The interconnection system of claim 18, wherein the number of switch cards is equal to the number of function cards.

20. The interconnection system of claim 18, wherein each of said plurality of switch cards is oriented substantially perpendicular to the function cards.

21. The interconnection system of claim 18, wherein the switch devices and the mid-connect elements are configured to enable full duplex signal propagation.

22. The interconnection system of claim 18, wherein the switch devices are transceiver switches.

23. The interconnection system of claim 22, wherein each of the transceiver switches establishes full duplex switching.

24. The interconnection system of claim 18, wherein the function cards and the switch cards are coupled to one another through a printed circuit board.

25. The interconnection system of claim 24, wherein the printed circuit board is a midplane structure.

26. A process for establishing data transmission connections among a plurality of function cards, the process comprising:
establishing on each of the function cards a first plurality of connector elements;
providing one or more switch cards, each of the switch cards including a second plurality of connector elements for coupling to the first plurality of connector elements; and
joining the first plurality of connector elements to the second plurality of connector elements so that the function cards are aligned non-parallel with respect to the one or more switch cards so that each function card is connected to each other function card.

27. The process of claim 26, wherein the function cards are arranged substantially perpendicular to the one or more switch cards.
